(19) United States
(12) Patent Application Publication
(10) Pub. No.: US 2025/0284974 A1
(43) Pub. Date: Sep. 11, 2025

(54) DISTRIBUTED GRAPH SAMPLING

(71) Applicant: Hewlett Packard Enterprise Development LP, Spring, TX (US)

(72) Inventors: Aditya Dhakal, Santa Clarita, CA (US); Sai Rahul Chalamalasetti, Milpitas, CA (US); Liad Gerstman, Kiryat Bialik (IL); Dejan Milojicic, Milpitas, CA (US)

(21) Appl. No.: 18/601,531

(22) Filed: Mar. 11, 2024

(51) Int. Cl. G06N 3/10; H04L 12/64

(52) U.S. Cl. CPC G06N 3/10; H04L 12/6418; H04L 2012/6443

(57) ABSTRACT

A distributed graph sampling system includes storage nodes that store a graph, a network switch that orchestrates accelerated sampling of the graph, and a compute node that processes a sample of the graph with a GNN. The graph sampling operations are distributed across the storage nodes. Each storage node may store a subgraph (e.g., a portion of the graph) and generate a sample of the subgraph.

### BACKGROUND

Graph neural networks (GNNs) are a class of machine learning algorithms designed to process and analyze data represented as graphs. They have gained prominence in various domains, such as traffic analysis, social networks, recommendation systems, biology, etc. GNNs operate by aggregating information from nodes in a graph, enabling them to identify relationships and patterns within the data. A GNN includes multiple layers, each of which refines the node embeddings of a graph through a combination of node features and information from neighboring nodes. GNNs are useful for tasks such as node classification, link prediction, and graph classification.

### BRIEF DESCRIPTION OF THE DRAWINGS

Aspects of the present disclosure are best understood from the following detailed description when read with the accompanying figures.

FIG. 1 is a diagram of a distributed graph sampling system, according to some implementations.

FIG. 2 is a diagram illustrating the partitioning of a graph, according to some implementations.

FIG. 3 is a sequence diagram of a distributed graph sampling method, according to some implementations.

FIG. 4 is a diagram of a network switch, according to some implementations.

FIG. 5 is a diagram of a network switch graph sampling method, according to some implementations.

FIG. 6 is a diagram of a storage node, according to some implementations.

FIG. 7 is a sequence diagram of a storage node graph sampling method, according to some implementations.

FIG. 8 is a diagram of a NIC graph sampling method, according to some implementations.

Corresponding numerals and symbols in the different figures generally refer to corresponding parts unless otherwise indicated. The figures are drawn to clearly illustrate the relevant aspects of the disclosure and are not necessarily drawn to scale.

### DESCRIPTION

The following disclosure provides many different examples for implementing different features. Specific examples of components and arrangements are described below to simplify the present disclosure. These are, of course, merely examples and are not intended to be limiting.

A graph represents the relations between a collection of entities. Specifically, a graph includes nodes (corresponding to the entities) and edges (corresponding to the relations between the entities). A graph neural network (GNN) includes multiple layers. When processing a graph with a GNN, the network operates in multiple iterations, where each layer updates the embeddings of nodes in the graph. At each layer, the GNN aggregates information from neighboring nodes, updates the embedding of each node, and then moves to the next layer. This process continues for a fixed number of layers or until a convergence criterion is met.

A graph may consume a large amount of memory, such that a graph may not fit into the memory of a processor or an accelerator. Because of this, a graph may be distributed across multiple storage nodes that, collectively, store the graph. Specifically, the graph elements (i.e., graph nodes and graph edges) of a graph may be distributed across the storage nodes. Distributing a graph across multiple storage nodes may raise new challenges for some operations, including graph sampling.

The present disclosure describes techniques for accelerating distributed graph sampling. A distributed graph sampling system includes storage nodes that store a graph, a network switch that orchestrates accelerated sampling of the graph, and a compute node that processes a sample of the graph with a GNN. The graph sampling operations are distributed across the storage nodes, which may increase the scalability of graph sampling. In some circumstances where a graph is large, processing a sample of the graph with a GNN may be more efficient than processing the entirety of the graph with a GNN, while still affording a desired level of accuracy. Additionally, distributing graph sampling may make the training of large-scale GNNs more feasible.

Each storage node may store a subgraph (e.g., a portion of the graph) and generate a sample of the subgraph. The network switch may be a Smart Switch that performs both network switching and also programmed computations. The network switch receives the subgraph samples from the storage nodes and aggregates the subgraph samples into a combined graph sample of the graph. Additionally, the network switch optimizes the graph sample by removing duplicate graph edges from the graph sample. In some implementations, a hash table for the graph is stored at the network switch and is used to identify the duplicate graph edges in the graph sample. The graph sample may then be sent to the compute node for processing with a GNN.

An accelerator of a storage node may perform a subgraph sampling operation. In some implementations, the storage nodes use a shared memory architecture, in which an accelerator of a storage node may directly access a shared memory region of the storage node, e.g., via a compute express link (CXL) interconnection.

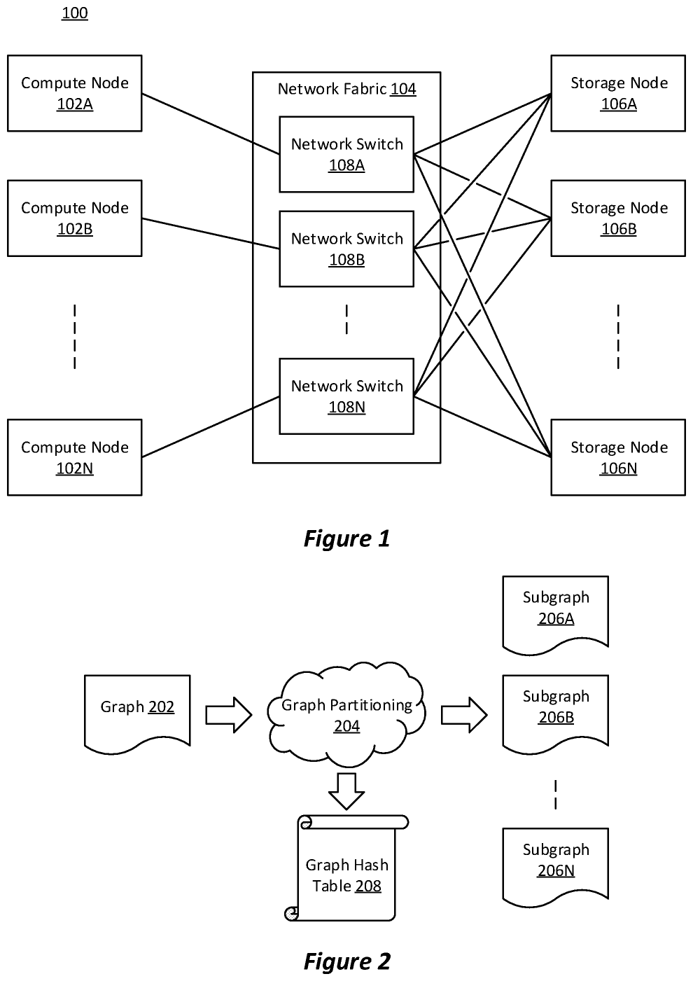

FIG. 1 is a diagram of a distributed graph sampling system 100, according to some implementations. The distributed graph sampling system 100 may be part of a computing environment, such as an HPC environment, that utilizes a client-server architecture to distribute and accelerate graph sampling across a network of interconnected components. The architecture of the distributed graph sampling system 100 enables efficient storage and sampling of a large-scale graph (and processing of graph samples for the graph), which would be impractical for single-node systems due to memory constraints. The distributed graph sampling system 100 includes multiple compute nodes 102 (including compute nodes 102A, 102B, . . . and 102N), a network fabric 104, and multiple storage nodes 106 (including storage nodes 106A, 106B, . . . and 106N).

The compute nodes 102 are the primary processing units within the distributed graph sampling system 100 for processing graph samples with graph neural network (GNN) algorithms. In some circumstances where a graph is large, processing a graph sample with GNN algorithms may be more efficient than processing the entirety of the graph with GNN algorithms, while still affording a desired level of accuracy. Each compute node 102 may be a standalone unit (e.g., high-performance server) equipped with processors capable of handling complex computational tasks such as updating graph node embeddings, aggregating neighborhood information, and evaluating a GNN's loss function. Additionally, or alternatively, the compute nodes 102 may include specialized hardware accelerators to further enhance their processing capabilities for machine learning tasks. Further, the compute nodes 102 include local memory where intermediary computation results may be temporarily stored.

The network fabric 104 is a high-bandwidth communication infrastructure that interconnects the compute nodes 102 and the storage nodes 106. It is designed to facilitate the quick and reliable transfer of large volumes of data required for distributed graph storage and sampling. The network fabric 104 may employ low-latency protocols and advanced networking technologies, such as InfiniBand or high-speed Ethernet, to maintain synchronicity and coordination across the distributed graph sampling system 100.

The storage nodes 106 are dedicated data storage units that store and maintain a large-scale graph in a distributed manner. Each storage node 106 may be a standalone unit (e.g., network-attached storage server) equipped with a large-capacity memory that stores a subgraph of the graph, e.g., a subset of the graph elements of the graph. The distribution of a graph across multiple storage nodes 106 enables efficient storage of a graph that may be infeasible to store on a single node. Additionally, distributing the graph across multiple storage nodes 106 enables parallel graph sampling operations, as different subgraphs of the graph can be retrieved and sampled concurrently.

The storage nodes 106 are equipped with their own processing capabilities (e.g., CPUs, accelerators, and the like) to assist in preprocessing or sampling tasks before transferring graph data through the network fabric 104 to the compute nodes 102. This localized processing at the storage nodes 106 helps alleviate bottlenecks by reducing the amount of raw data that needs to traverse the distributed graph sampling system 100. Furthermore, and as subsequently described in greater detail, the architecture of the storage nodes 106 allows for the incorporation of Shared Virtual Memory (SVM), enabling the accelerators of the storage nodes 106 to directly access desired graph data from memory of the storage nodes 106, without involving the CPUs of the storage nodes 106 in data movement tasks.

The network fabric 104 includes network switches 108 (including network switches 108A, 108B, . . . and 108N), which connect the storage nodes 106 to the compute nodes 102. The network switches 108 are Smart Switches (with embedded computational capabilities) that are used for both networking and computing operations. Specifically, the network switches 108 may switch network packets between the storage nodes 106 and the compute nodes 102, and may also perform computing operations for graph sampling.

As subsequently described in greater detail, a compute node 102 initiates a graph sampling operation by communicating with the storage nodes 106 through a network switch 108 of the network fabric 104. The network switch 108 requests specific subgraph samples from the storage nodes 106. Upon receiving these requests, the storage nodes 106 generate appropriate subgraph samples from their stored subgraphs of the graph. The subgraph samples are then transmitted to the network switch 108. The embedded computational functionalities of the network switch 108 may then be used to aggregate the subgraph samples into a graph sample. The network switch 108 may also optimize the graph sample for processing by the compute node 102 by performing graph edge deduplication. Specifically, the network switch 108 may utilize intelligent hashing mechanisms to remove duplicate graph edges from the graph sample, which may help manage data flow across the distributed graph sampling system 100. The compute node 102 then receives the optimized graph sample (which is representative of the large-scale graph) from the network switch 108 and processes the graph sample with GNN algorithms.

The network fabric 104 may have any topology. For example, the network fabric 104 may have a spine-leaf architecture, in which the network switches 108 may be spine switches or leaf switches. In the illustrated example, each compute node 102 is connected to a respective network switch 108, which is connected to each of the storage nodes 106. For example, the compute node 102A is connected to each of the storage nodes 106 via the network switch 108A; the compute node 102B is connected to each of the storage nodes 106 via the network switch 108B; and the compute node 102N is connected to each of the storage nodes 106 via the network switch 108N. Thus, each network switch 108 may (for a respective compute node 102) aggregate samples that represent the entire graph stored in the storage nodes 106. Other topologies may be utilized. For example, the network fabric 104 may have a layered architecture, including multiple tiers of the network switches 108.

FIG. 2 is a diagram illustrating the partitioning of a graph 202, according to some implementations. Specifically, the graph 202 is partitioned by a graph partitioning algorithm 204 into multiple subgraphs 206 (including subgraphs 206A, 206B, . . . and 206N), each of which is a portion of the graph 202. Doing so allows the subgraphs 206 to be distributed across the storage nodes of a distributed graph sampling system. Each subgraph 206 may be stored on a respective storage node. For example, the subgraph 206A may be stored on the storage node 106A of the distributed graph sampling system 100 (see FIG. 1); the subgraph 206B may be stored on the storage node 106B; and the subgraph 206N may be stored on the storage node 106N.

The graph partitioning algorithm 204 may include several operations. The graph partitioning algorithm 204 may distribute the graph elements of the graph 202 across the subgraphs 206. The graph elements may be distributed uniformly so as to reduce the risk of a particular subgraph 206 becoming a hotspot. The distribution may be performed in a manner that minimizes the number of inter-subgraph connections between the graph nodes of the subgraphs (which may be referred to as “edge cuts”). Reducing edge cuts may lessen the amount of inter-storage-node communication that is needed for sampling the graph 202. The distribution may also maintain local neighborhoods of graph nodes within the same subgraph 206, when feasible.

When partitioning the graph 202, the graph partitioning algorithm 204 also generates a graph hash table 208. The graph hash table 208 acts as an index of which subgraphs 206 contain which graph elements, which may be used to identify which storage nodes (used to store the subgraphs 206) are storing which graph elements. Thus, the graph hash table 208 may be used to quickly locate graph elements across the storage nodes used to store the subgraphs 206. The graph hash table 208 may be stored on one or more network switches, which may use the graph hash table 208 to map the graph elements to storage nodes that store the graph elements. For example, the graph hash table 208 may be stored on the network switches 108 of the distributed graph sampling system 100 (see FIG. 1). Additionally, the network switches may use the graph hash table 208 as a routing table for forwarding packets to the storage nodes. Doing so may increase the speed of accessing a graph element from its storage location.

The graph elements of a graph mode may have identifiers. The graph hash table 208 may be a dictionary having a key-value structure. The keys of the graph hash table 208 include the identifiers of the graph elements. The values of the graph hash table 208 include the locations of the respective graph elements (e.g., indications of which subgraphs contains which graph elements). As such, the graph hash table 208 may be used to map the identifiers of the graph elements to the storage nodes which store the subgraphs 206 containing the graph elements. The graph partitioning algorithm 204 may reduce hash collisions in the keys of the graph hash table 208 through any suitable collision resolution technique, such as chaining, open addressing, or the like.

The graph partitioning algorithm 204 may be performed offline (e.g., by a computing node). The graph partitioning algorithm 204 may be informed by the architecture of the graph sampling system on which the distributed graph will be stored. For example, the graph partitioning algorithm 204 may accept, as input, information about the number of compute nodes and storage nodes in the graph sampling system, as well as the topology of the network fabric (including how the compute nodes and storage nodes will be connected to network switches) in the graph sampling system.

The graph hash table 208 and/or the subgraphs 206 may be periodically updated by the graph partitioning algorithm 204. For example, when the graph 202 changes (e.g., due to the adding or removal of graph elements), the subgraphs 206 may be rebalanced and the graph hash table 208 may be updated based on the rebalancing of the subgraphs 206.

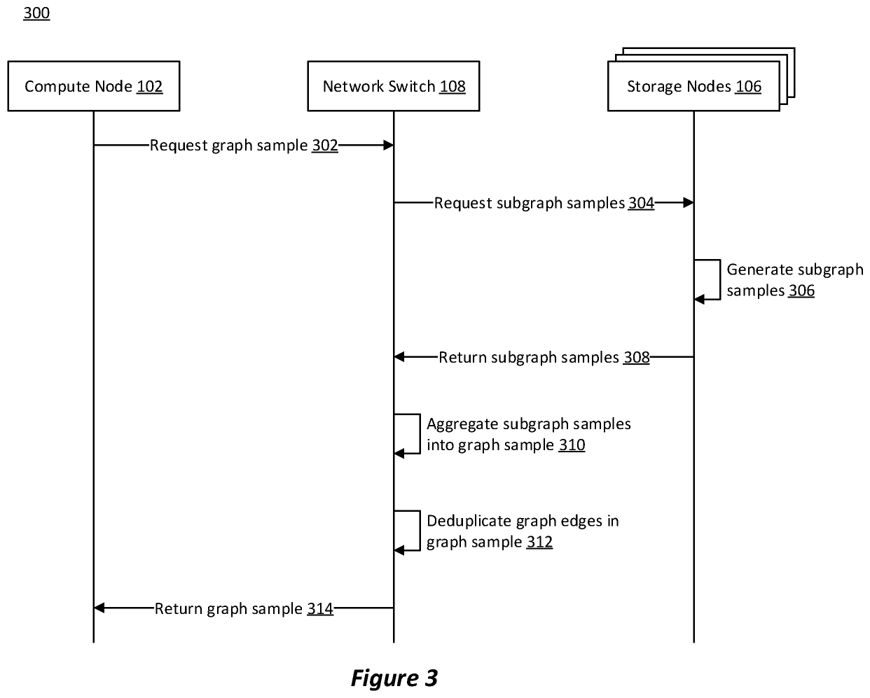

FIG. 3 is a sequence diagram of a distributed graph sampling method 300, according to some implementations. The distributed graph sampling method 300 may be performed in a distributed graph sampling system, such as the distributed graph sampling system 100 (see FIG. 1), when a compute node 102 requests a sample of a distributed graph that is stored across multiple storage nodes 106.

In step 302, the compute node 102 requests a sample of the graph from a network switch 108. In the example where each compute node 102 is connected to a respective network switch 108, the graph sample request may be sent to the network switch 108 which is connected to the compute node 102. The graph sample request may indicate one or more graph node(s) that should be included in the sample of the graph mode. For example, the graph sample request may include one or more identifier(s) of graph node(s).

In step 304, the network switch 108 requests samples of subgraphs from the storage nodes 106. The samples may be requested for the subgraphs which contain the graph node(s) identified by the graph sample request. As previously noted, the subgraphs may be stored on the storage nodes 106, while a graph hash table may be stored on the network switch 108. The network switch 108 may use the graph hash table to identify the storage nodes 106 that contain the needed subgraphs. For example, the network switch 108 may use the graph hash table as a routing table to forward the graph sample request from the compute node 102 to the desired storage nodes 106.

In step 306, the storage nodes 106 (identified by the network switch 108) generate samples of their stored subgraphs. Each storage node 106 may generate a sample of its subgraph using any suitable graph sampling technique. Examples of graph sampling techniques include random sampling, neighborhood sampling, and the like. In some implementations, a random sampling algorithm such as GraphSAGE may be used by a storage node 106 to randomly select nodes of its subgraph. The subgraph samples may be generated in parallel across the storage nodes 106. Details regarding how a storage node 106 samples its subgraph will be subsequently described.

In step 308, the storage nodes 106 return the samples of their respective subgraphs to the network switch 108. The network switch 108 thus receives the subgraph samples from the storage nodes 106 it previously identified. The subgraph samples (collectively) contain the graph node(s) indicated by the graph sample request.

In step 310, the network switch 108 aggregates the subgraph samples from the storage nodes 106 into a combined sample of the graph. For example, the graph elements (including the graph nodes and the graph edges) in each subgraph sample may be concatenated into a combined graph sample. When a graph is partitioned, there may be some edge cuts in the partitioned graph. As a result, a graph edge stored in a first storage node 106 may connect graph nodes stored in a second storage node 106. When the subgraphs contain edge cuts, the combined graph sample may include duplicate graph edges. As previously noted, the network switch 108 is a Smart Switch with embedded computational capabilities that may perform the aggregation.

In step 312, the network switch 108 deduplicates the graph edges in the combined graph sample. The duplicate graph edges may be removed from the combined graph sample, such that the combined graph sample includes only one instance of each graph edge. The network switch 108 may use the graph hash table stored at the network switch 108 to identify duplicate graph edges in the combined graph sample. For example, because the graph hash table identifies the graph elements stored in the subgraph of each storage node 106, the network switch 108 may, based on the requested subgraph samples, expect certain graph edges to be duplicated in the subgraph samples. Those expected duplicate graph edges may be removed from the combined graph sample. Deduplicating graph edges in the combined graph sample may optimize the graph sample, such that fewer computing resources will be needed (by the compute node 102) to process the graph sample with GNN algorithms. As previously noted, the network switch 108 is a Smart Switch with embedded computational capabilities that may perform the deduplication.

In some implementations, the network switch 108 deduplicates the graph nodes in the combined graph sample. Graph node deduplication may be performed in lieu of or in addition to graph edge deduplication.

In step 314, the network switch 108 returns the combined graph sample to the compute node 102. The graph sample contains the graph node(s) indicated by the graph sample request from the compute node 102. Subsequently, the compute node 102 may process the graph sample with GNN algorithms.

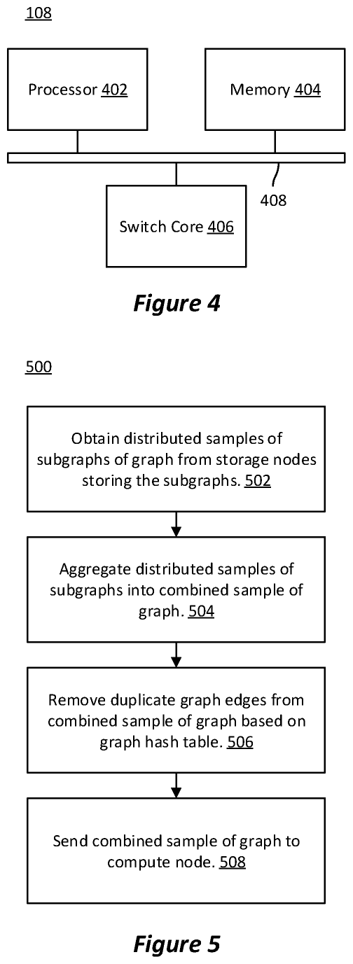

FIG. 4 is a diagram of a network switch 108, according to some implementations. The components of the network switch 108 can be implemented as integrated circuits, such as in one or more integrated circuit die(s) and/or one or more integrated circuit package(s).

To achieve its desired functionality, the network switch 108 includes various hardware components. These hardware components may include a processor 402, a memory 404, and a switch core 406. The hardware components may be interconnected through a number of busses and/or network connections. In one example, the processor 402, the memory 404, and the switch core 406 may be communicatively coupled via a bus 408, such as a PCI-Express bus.

The processor 402 retrieves executable code from the memory 404 and executes the executable code. The executable code may, when executed by the processor 402, cause the processor 402 to implement any functionality described herein. The processor 402 may be a microprocessor, an application-specific integrated circuit, a microcontroller, or the like.

The memory 404 may include various types of memory, including volatile and nonvolatile memory. For example, the memory 404 may include Random-Access Memory (RAM), Read-Only Memory (ROM), a Solid State Drive (SSD), the like, or combinations there. Different types of memory may be used for different data storage needs. For example, the processor 402 may boot from ROM, maintain nonvolatile storage in an SSD, execute program code stored in RAM, and store data under processing in RAM. The memory 404 may include a non-transitory computer readable medium that stores instructions for execution by the processor 402. One or more modules within the network switch 108 may be partially or wholly embodied as software and/or hardware for performing any functionality described herein.

The switch core 406 includes the components of the network switch 108 for switching and forwarding packets. Example components of the switch core 406 include ingress ports, egress ports, a switch fabric (e.g., crossbars, shared buses, shared memory, a chip-wide ring, etc.), and the like. The switch core 406 is connected to compute nodes and storage nodes.

FIG. 5 is a diagram of a network switch graph sampling method 500, according to some implementations. The network switch graph sampling method 500 may be performed by a network switch of a distributed graph sampling system when generating a sample of a graph.

The network switch performs a step 502 of obtaining distributed samples of subgraphs of a graph from storage nodes, the storage nodes storing the subgraphs, the graph comprising graph nodes connected by graph edges. A graph hash table is stored in the memory of the network switch. The graph hash table may be a dictionary having a key-value structure. The network switch may also perform steps of receive a sampling request from the compute node; and forward the sampling request to the storage nodes using the graph hash table as a routing table. The sampling request may comprise identifiers of particular graph nodes of the graph. Obtaining the distributed samples of the subgraphs may comprise selecting ones of the storage nodes based on the identifiers of the sampling request.

The network switch performs a step 504 of aggregating the distributed samples of the subgraphs into a combined sample of the graph. Aggregating the distributed samples of the subgraphs into the combined sample of the graph may comprise concatenating the distributed samples of the subgraphs.

The network switch performs a step 506 of removing duplicate ones of the graph edges from the combined sample of the graph based on the graph hash table stored in the memory, the graph hash table identifying the storage nodes that store the graph edges and the graph nodes. Removing the duplicate ones of the graph edges may include: identifying expected ones of the graph edges that will be duplicated in the distributed samples of the subgraphs based on the graph hash table; and removing the expected ones of the graph edges from the combined sample of the graph.

The network switch performs a step 508 of sending the combined sample of the graph to a compute node. Subsequently, the compute node 102 may process the combined sample of the graph with GNN algorithms.

Some variations are contemplated. As previously noted, the network fabric 104 may have a layered architecture having multiple tiers of the network switches 108. In such an implementation, the network switches 108 in a lower tier may aggregate and return combined subgraph samples to a network switch 108 in an upper tier. The network switch 108 in the upper tier may then aggregate the combined subgraph samples into the combined sample of the graph that is returned to a compute node 102.

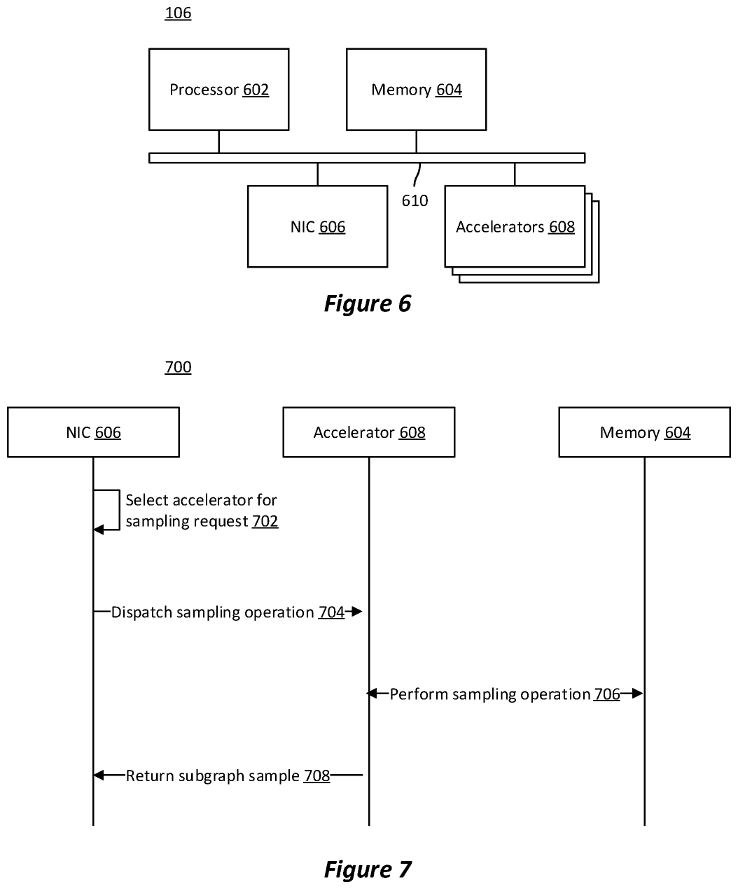

FIG. 6 is a diagram of a storage node 106, according to some implementations. The storage node 106 may be used to provide efficient and reliable storage, access, and sampling capabilities for the distributed handling of a large-scale graph.

To achieve its desired functionality, the storage node 106 includes various hardware components. These hardware components may include a processor 602, a memory 604, a network interface card (NIC) 606, and one or more accelerators 608. The hardware components may be interconnected through a number of busses and/or network connections. In one example, the processor 602, the memory 604, the NIC 606, and the accelerators 608 may be communicatively coupled via a bus 610, such as a PCI-Express bus.

The processor 602 retrieves executable code from the memory 604 and executes the executable code. The executable code may, when executed by the processor 602, cause the processor 602 to implement any functionality described herein. The processor 602 may be a microprocessor, an application-specific integrated circuit, a microcontroller, or the like. The processor 602 is a CPU of the storage node 106.

The memory 604 may include various types of memory, including volatile and nonvolatile memory. For example, the memory 604 may include Random-Access Memory (RAM), Read-Only Memory (ROM), a Solid State Drive (SSD), the like, or combinations there. Different types of memory may be used for different data storage needs. For example, the processor 602 may boot from ROM, maintain nonvolatile storage in an SSD, execute program code stored in RAM, and store data under processing in RAM. The memory 604 may include a non-transitory computer readable medium that stores instructions for execution by the processor 602. One or more modules within the storage node 106 may be partially or wholly embodied as software and/or hardware for performing any functionality described herein.

The NIC 606 may be used to connect to a network (e.g., LAN, WAN, etc.) and communicate with other devices over that network. The NIC 606 facilitates the transmission and reception of data packets between the storage node 106 and the network, and may adhere to one or more networking standards such as Ethernet, Wi-Fi, and the like. Additionally, the NIC 606 may support Remote Direct Memory Access (RDMA) for communicating with other nodes of a distributed graph sampling system. The NIC 606 may receive subgraph sample requests from a network switch (not illustrated in FIG. 6) and dispatch the subgraph sample requests to appropriate ones of the accelerators 608 for processing the requested subgraph samples. The NIC 606 may be a programmable NIC, such as a SmartNIC, having processing cores that can be programmed to perform the dispatching of subgraph sample requests.

The accelerators 608 are specialized processing units that can be programmed to perform operations for sampling a subgraph. Examples of the accelerators 608 include Graphics Processing Units (GPUs), Field Programmable Gate Arrays (FPGAs), Application-Specific Integrated Circuits (ASICs), and other specialized processing units, which may be incorporated into the storage node 106 to expedite graph-related computations. The accelerators 608 may include streaming multiprocessors. The accelerators 608 provide significant computational power, allowing for faster execution of tasks like graph sampling algorithms than a CPU (e.g., the processor 602).

The memory 604 stores a subgraph of a graph. The subgraph may have been previously obtained by partitioning the graph, as previously described for FIG. 2. The storage node 106 may include a Shared Virtual Memory (SVM) between the accelerators 608, the NIC 606, and the memory 604 (including RAM and/or SSDs). As a result, the memory 604 may include a shared memory region storing the subgraph, and the accelerators 608 and the NIC 606 may directly access the subgraph from the shared memory region. A system interconnect communication protocol that supports coherent memory access may be used to interconnect the memory 604 with the accelerators 608 and the NIC 606. In some implementations, the memory 604 is interconnected with the accelerators 608 and the NIC 606 by a Compute Express Link (CXL) interconnect, a Cache Coherent Interconnect for Accelerators (CCIX), a Coherent Accelerator Processor Interface (CAPI), or the like. The use of an SVM allows the components of the storage node 106 to directly access and utilize shared data without redundant data movement (through the processor 602), thereby increasing efficiency.

FIG. 7 is a sequence diagram of a storage node graph sampling method 700, according to some implementations. The storage node graph sampling method 700 may be performed by a storage node of a distributed graph sampling system when generating a sample of a subgraph stored in the memory of the storage node.

In step 702, the NIC 606 selects an accelerator 608 to perform a subgraph sampling operation. The accelerator 608 may be selected in response to the NIC 606 receiving a subgraph sample request from a network switch (not illustrated in FIG. 7). The subgraph sample request may indicate graph node(s) that exist in the subgraph stored in the memory 604, which graph node(s) should be included in the requested subgraph sample. The selected accelerator 608 may be one that is suitable for performing a desired sampling operation and is available (e.g., not performing another sampling operation).

In step 704, the NIC 606 dispatches a subgraph sampling operation to the selected accelerator 608. For example, the NIC 606 may launch a kernel (which includes the subgraph sampling operation) on the selected accelerator 608. The kernel generates a desired sample of the subgraph.

In step 706, the selected accelerator 608 performs the subgraph sampling operation on the subgraph stored in the memory 604 of the storage node, thus producing the requested sample of the subgraph. As an example of the subgraph sampling operation, the selected accelerator 608 may locate the graph node(s) indicated by the subgraph sample request, and perform a neighborhood sampling algorithm with those graph node(s). Due to the SVM, the selected accelerator 608 may directly access the subgraph from the shared memory region of the memory 604 via a system interconnect, without involving the CPU.

In step 708, the selected accelerator 608 returns the subgraph sample to the NIC 606. For example, the selected accelerator 608 may put the subgraph sample in the memory 604 and notify the NIC 606 that the subgraph sample is ready. The NIC 606 may then directly read the subgraph sample from the memory 604 and forward the subgraph sample to the network switch (not illustrated in FIG. 7) from which it received the subgraph sample request.

A storage node may handle multiple subgraph sample requests simultaneously. For example, a first sampling operation for a first subgraph sample request may be dispatched to a first accelerator 608 while a second sampling operation for a second subgraph sample request may be dispatched to a second accelerator 608. The first and second accelerators 608 may perform their sampling operations in parallel, with both directly accessing needed graph node(s) of the subgraph from the memory 604.

As previously noted, the NIC 606 may be a SmartNIC. The selecting and dispatching steps may be performed by the NIC 606. Further, the selected accelerator 608 and the NIC 606 may obtain the needed graph data and subgraph sample from the memory 604. Thus, processing of a subgraph sample may be coordinated by the NIC 606, without involving the CPU of the storage node and without copying graph data into a memory of the selected accelerator 608. Overhead for a CPU of the storage node may thus be reduced.

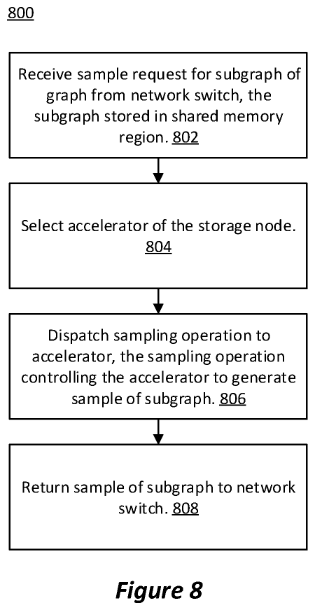

FIG. 8 is a diagram of a NIC graph sampling method 800, according to some implementations. The NIC graph sampling method 800 may be performed by a NIC of a storage node when generating a sample of a graph.

The NIC performs a step 802 of receiving a sample request for a subgraph of a graph from a network switch, a memory of the storage node storing the subgraph in a shared memory region, the graph comprising graph nodes connected by graph edges. The sample request may identify one or more of the graph nodes of the graph.

The NIC performs a step 804 of selecting an accelerator of the storage node. The accelerator may be a streaming multiprocessor.

The NIC performs a step 806 of dispatching a sampling operation to the accelerator, the sampling operation controlling the accelerator to generate a sample of the subgraph, the accelerator directly reading the subgraph from the shared memory region, the accelerator directly writing the sample of the subgraph to the shared memory region. The sampling operation is dispatched directly to the accelerator without copying the subgraph to an onboard memory of the accelerator. The sampling operation may comprise neighborhood sampling performed with the one of the graph nodes identified by the sample request.

The NIC performs a step 808 of returning the sample of the subgraph to the network switch. Returning the sample of the subgraph to the network switch may comprise directly reading the sample of the subgraph from the shared memory region.

Embodiments may achieve advantages. The distributed graph sampling system 100 provides enhanced scalability for processing large-scale graphs through distributed storage and computation. Additionally, sampling time may be reduced due to parallel operation across the storage nodes 106. Further, communication overhead may be reduced due to the intelligent graph sample aggregation and deduplication performed by the network switches 108.

The foregoing outlines features of several examples so that those skilled in the art may better understand the aspects of the present disclosure. Various modifications and combinations of the illustrative examples, as well as other examples, will be apparent to persons skilled in the art upon reference to the description. It is therefore intended that the appended claims encompass any such modifications.

What is claimed is:

1. A system comprising:
a plurality of storage nodes configured to:
store a graph comprising graph nodes connected by graph edges; and
generate subgraph samples of the graph;
a network switch configured to:
receive the subgraph samples from the storage nodes;
aggregate the subgraph samples into a graph sample of the graph; and
remove duplicate ones of the graph edges from the graph sample based on a graph hash table stored at the network switch, the graph hash table identifying the storage nodes that store the graph edges and the graph nodes; and
a compute node configured to:
receive the graph sample from the network switch; and
process the graph sample with a graph neural network algorithm.

2. The system of claim 1, wherein each of the storage nodes comprises:
a memory storing a subgraph of the graph in a shared memory region;
a plurality of accelerators; and
a network interface card configured to:
receive a subgraph sample request from the network switch; and
dispatch a subgraph sampling operation to a selected accelerator of the accelerators, the selected accelerator configured to directly access the subgraph of the graph from the shared memory region.

3. The system of claim 2, wherein the memory is interconnected with the accelerators and the network interface card by a compute express link (CXL) interconnect.

4. The system of claim 2, wherein the network interface card is a SmartNIC.

5. The system of claim 1, wherein the network switch is a Smart Switch.

6. The system of claim 1, wherein the network switch is further configured to forward a subgraph sample request from the compute node to the storage nodes using the graph hash table as a routing table.

7. The system of claim 1, wherein the network switch removes the duplicate ones of the graph edges from the graph sample by:
identifying expected ones of the graph edges that will be duplicated in the subgraph samples based on the graph hash table; and
removing the expected ones of the graph edges from the graph sample.

8. The system of claim 1, wherein the graph hash table is a dictionary having a key-value structure.

9. A network switch comprising:
a switch core;
a processor; and
a memory comprising a non-transitory computer readable medium storing instructions which, when executed by the processor, cause the processor to:
obtain distributed samples of subgraphs of a graph from storage nodes, the storage nodes storing the subgraphs, the graph comprising graph nodes connected by graph edges;
aggregate the distributed samples of the subgraphs into a combined sample of the graph;
remove duplicate ones of the graph edges from the combined sample of the graph based on a graph hash table stored in the memory, the graph hash table identifying the storage nodes that store the graph edges and the graph nodes; and
send the combined sample of the graph to a compute node.

10. The network switch of claim 9, wherein the non-transitory computer readable medium stores further instructions which, when executed by the processor, cause the processor to:
receive a sampling request from the compute node; and
forward the sampling request to the storage nodes using the graph hash table as a routing table.

11. The network switch of claim 10, wherein the sampling request comprises identifiers of particular graph nodes of the graph, and obtaining the distributed samples of the subgraphs comprises selecting ones of the storage nodes based on the identifiers of the sampling request.

12. The network switch of claim 9, wherein aggregating the distributed samples of the subgraphs into the combined sample of the graph comprises concatenating the distributed samples of the subgraphs.

13. The network switch of claim 9, wherein removing the duplicate ones of the graph edges comprises:
identifying expected ones of the graph edges that will be duplicated in the distributed samples of the subgraphs based on the graph hash table; and
removing the expected ones of the graph edges from the combined sample of the graph.

14. The network switch of claim 9, wherein the graph hash table is a dictionary having a key-value structure.

15. A method, by a network interface card of a storage node, the method comprising:
receiving a sample request for a subgraph of a graph from a network switch, a memory of the storage node storing the subgraph in a shared memory region, the graph comprising graph nodes connected by graph edges;
selecting an accelerator of the storage node;
dispatching a sampling operation to the accelerator, the sampling operation controlling the accelerator to generate a sample of the subgraph, the accelerator directly reading the subgraph from the shared memory region, the accelerator directly writing the sample of the subgraph to the shared memory region; and
returning the sample of the subgraph to the network switch.

16. The method of claim 15, wherein returning the sample of the subgraph to the network switch comprises directly reading the sample of the subgraph from the shared memory region.

17. The method of claim 15, wherein the accelerator is a streaming multiprocessor.

18. The method of claim 15, wherein the sampling operation is dispatched to the accelerator without copying the subgraph to an onboard memory of the accelerator.

19. The method of claim 15, wherein the sample request identifies one of the graph nodes of the graph.

20. The method of claim 19, wherein the sampling operation comprises neighborhood sampling performed with the one of the graph nodes identified by the sample request.
